(19) United States
(12) Patent Application Publication
(10) Pub. No.: US 2025/0345909 A1
(43) Pub. Date: Nov. 13, 2025

(54) FASTENER DRIVER

(71) Applicant: Nanjing Chervon Industry Co., Ltd., Nanjing (CN)

(72) Inventors: Guangcheng Sun, Nanjing (CN); Hongbin Wang, Nanjing (CN)

(21) Appl. No.: 19/095,261

(22) Filed: Mar. 31, 2025

(30) Foreign Application Priority Data
May 8, 2024 (CN) 202410569891.6

(51) Int. Cl. B25C 1/04; B25C 1/06

(52) U.S. Cl. CPC B25C 1/041; B25C 1/06

(57) ABSTRACT

A fastener driver includes a cylinder assembly including a first cylinder, where the first cylinder connects with the outside atmosphere when the striking member is at the stop position; and a first piston disposed in the first cylinder, where the first piston is at the initial position when the striking member is at the stop position. One time of gas compression is completed when the first piston moves from the initial position to the maximum compression position, and the striking member is released from the stop position when the first piston reaches the maximum compression position for the Nth time.

### RELATED APPLICATION INFORMATION

This application claims the benefit under 35 U.S.C. § 119(a) of Chinese Patent Application No. CN 202410569891.6, filed on May 8, 2024, which application is incorporated herein by reference in its entirety.

### BACKGROUND

In actual production and daily life, nails are sometimes needed to connect or fix objects. Manual knocking results in high labor intensity and low efficiency. Therefore, in the related art, a nail gun is usually used to perform the nailing action. The nail gun is a fastener driver for quickly driving nails into a working surface. A compressed air-driven nail gun has a compressed air-driven cylinder, and the thrust generated by the extension of a cylinder piston rod is used as the driving force acting on an impact part, thereby driving the nail into the working surface. A mechanical spring-loaded nail gun has an impact spring (compression spring). After the impact spring is compressed, the restoring force of the spring is used as the driving force acting on the impact part, thereby driving the nail into the working surface.

Since the requirements for the nailing efficiency and nailing force are upgraded constantly, higher pressure needs to be acquired in the process of compressing air to store energy in order that the compressed air-driven nail gun can acquire a stronger nailing capability. However, due to the limited space of the housing of the compressed air-driven nail gun, under the premise that the volume of the cylinder is fixed, it is difficult to provide a stronger driving force to the piston.

This part provides background information related to the present application, and the background information is not necessarily the existing art.

### SUMMARY

A fastener driver includes a striking assembly including a striking member configured to strike a fastener; and a power mechanism including a gas spring mechanism for driving the striking member. The gas spring mechanism includes at least a cylinder assembly including a first cylinder, where the first cylinder connects with the outside atmosphere in the case where the striking member is at the stop position; and a first piston disposed in the first cylinder, where the first piston is at the initial position in the case where the striking member is at the stop position. One time of gas compression is completed in the case where the first piston moves from the initial position to the maximum compression position, and the striking member is released from the stop position in the case where the first piston reaches the maximum compression position for the Nth time, where N is greater than or equal to 2.

In some examples, an energy storage cylinder unidirectionally connecting with the first cylinder and configured to store compressed gas is further included.

In some examples, a first valve disposed at the connection between the energy storage cylinder and the first cylinder and allowing gas in the first cylinder to flow into the energy storage cylinder is further included.

In some examples, a second cylinder is further included, where the striking member is disposed in the second cylinder.

In some examples, a second valve disposed at the connection between the energy storage cylinder and the second cylinder of the cylinder assembly and allowing gas to flow between the energy storage cylinder and the second cylinder is further included.

In some examples, the power mechanism further includes an electric motor, and in the case where the rotational parameter of the electric motor is greater than or equal to a parameter threshold, the second valve opens to allow the compressed gas in the energy storage cylinder to enter the second cylinder to push the striking member to strike the fastener.

In some examples, the second valve is configured to open automatically when the air pressure in the energy storage cylinder is greater than or equal to an air pressure threshold.

In some examples, a third valve disposed at the connection between the first cylinder and the second cylinder and allowing gas to flow from the second cylinder into the first cylinder is further included.

In some examples, the third valve includes a one-way valve.

In some examples, a fourth valve disposed on the second cylinder and capable of allowing gas in the second cylinder to flow to the outside in the case where the striking member is at the striking position is further included.

In some examples, a transmission assembly is further included, where the transmission assembly is drivingly connected to the power mechanism and the second valve, respectively.

In some examples, the power mechanism is capable of controlling, through the transmission assembly, the second valve to open or close.

In some examples, the transmission assembly includes a first bevel gear and a second bevel gear meshing with each other, and the second bevel gear is drivingly connected to the second valve.

In some examples, the second valve opens when the first piston reaches the maximum compression position for the Nth time.

In some examples, an air supply port is disposed on the first cylinder; and in the case where the striking member is at the stop position, the first piston is at the initial position, and the air supply port enables the first cylinder to connect with the outside.

A fastener driver includes a striking assembly including a striking member configured to strike a fastener; and a power mechanism including a gas spring mechanism for driving the striking member. The gas spring mechanism includes at least a cylinder assembly including a first cylinder, where the first cylinder connects with the outside atmosphere in the case where the striking member is at the stop position; and a first piston disposed in the first cylinder, where the first piston is at the initial position in the case where the striking member is at the stop position. One time of gas compression is completed in the case where the first piston moves from the initial position to the maximum compression position, and the striking member is maintained at the stop position in the case where the first piston reaches the maximum compression position for the first time.

A fastener driver includes a striking assembly including a striking member configured to strike a fastener; and a power mechanism including a gas spring mechanism for driving the striking member. The gas spring mechanism includes at least a cylinder assembly including a first cylinder, where the first cylinder connects with the outside atmosphere in the case where the striking member is at the stop position; an energy storage cylinder unidirectionally connecting with the first cylinder and configured to store compressed gas; and a second cylinder connecting with at least the energy storage cylinder, where the striking member is disposed in the second cylinder, and the striking member is pushed by the compressed gas to strike the fastener.

In some examples, a first valve disposed at the connection between the energy storage cylinder and the first cylinder and allowing gas in the first cylinder to flow into the energy storage cylinder is further included.

In some examples, a second valve disposed at the connection between the energy storage cylinder and the second cylinder and allowing gas to flow between the energy storage cylinder and the second cylinder is further included.

In some examples, the power mechanism further includes an electric motor, and in the case where the rotational parameter of the electric motor is greater than or equal to a parameter threshold, the second valve opens to allow the compressed gas in the energy storage cylinder to enter the second cylinder to push the striking member to strike the fastener.

In some examples, the second valve is configured to open automatically when the air pressure in the energy storage cylinder is greater than or equal to an air pressure threshold.

In some examples, a third valve disposed at the connection between the first cylinder and the second cylinder and allowing gas to flow from the second cylinder into the first cylinder is further included.

In some examples, a fourth valve disposed on the second cylinder and capable of allowing gas in the second cylinder to flow to the outside in the case where the striking member is at the striking position is further included.

In some examples, a first piston disposed in the first cylinder is further included, the first piston is at the initial position in the case where the striking member is at the stop position, one time of gas compression is completed in the case where the first piston moves from the initial position to the maximum compression position, and the second valve opens when the first piston reaches the maximum compression position for the Nth time.

In some examples, N is greater than or equal to 2.

In some examples, a first piston disposed in the first cylinder is further included, an air supply port is disposed on the first cylinder, the first piston is at the initial position in the case where the striking member is at the stop position, and the air supply port connects the first cylinder with the outside.

### BRIEF DESCRIPTION OF THE DRAWINGS

FIG. 1 is a front view of a fastener driver.

FIG. 2 is a schematic view of a fastener driver.

FIG. 3 is a schematic view of a fastener driver with a housing removed.

FIG. 4 is a schematic view of an electric motor and a deceleration mechanism in a fastener driver.

FIG. 5 is a sectional view illustrating that a first piston in a fastener driver is at the initial position.

FIG. 6 is a sectional view illustrating that a first piston in a fastener driver is at the maximum compression position.

FIG. 7 is a sectional view illustrating that a first piston in a fastener driver returns to the initial position.

FIG. 8 is a sectional view illustrating that a first piston in a fastener driver is at the maximum compression position for the second time.

FIG. 9 is a sectional view illustrating that a second piston in a fastener driver is at the top dead center.

FIG. 10 is a sectional view that a first piston and a second piston in a fastener driver are reset.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

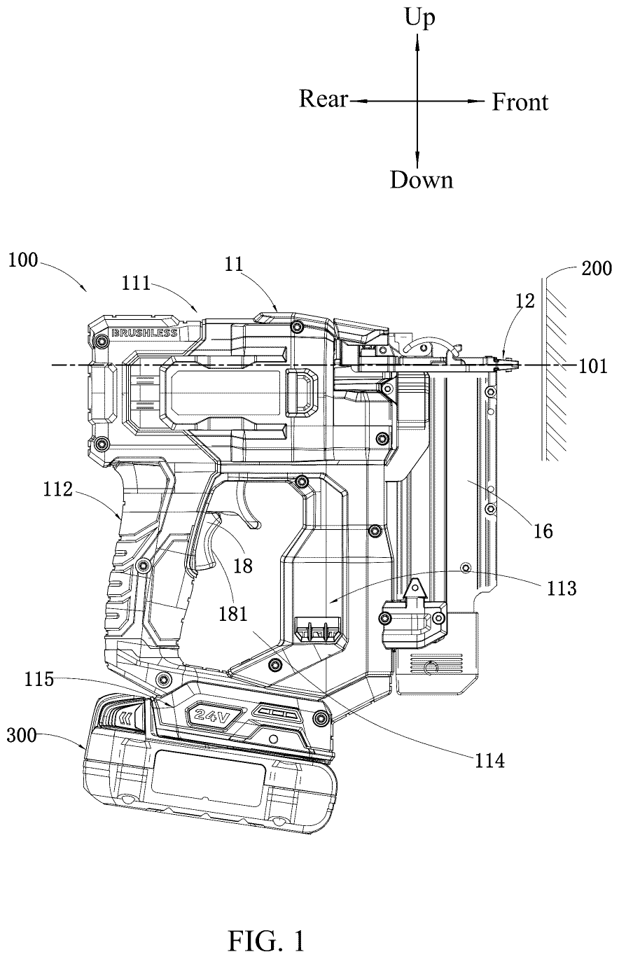

To clearly illustrate the technical solutions of the present application, an upper side, a lower side, a front side, and a rear side shown in FIG. 1 are further defined.

FIG. 1 shows a fastener driver 100 in an example of the present application. The fastener driver 100 is used for driving a fastener (not shown) into a working surface 200. For example, the fastener is a nail, and the nail may be a straight nail or a U-shaped nail. The fastener driver 100 quickly drives the fastener into the working surface 200, thereby fixing the working surface 200 to the platform on the back side of the working surface 200. In this example, the fastener driver 100 is, for example, a nail gun. Optionally, the fastener driver 100 includes a mechanical spring-loaded nail gun that utilizes the force of the compressed coil spring as an impact force (for example, a driving force). Optionally, the fastener driver 100 is a cylinder-type nail gun that compresses the gas in the cylinder so that the compressed gas pushes out a firing assembly 23 to perform the nailing action.

In some examples, the fastener driver 100 is a cylinder-type nail gun. For example, the fastener driver 100 does not require an external air pressure source. Instead, the fastener driver 100 includes pre-charged pressurized gas within a cylinder assembly 22. In some examples, the cylinder assembly 22 of the fastener driver 100 connects with the atmosphere, and gas flows into the cylinder in a preset state.

As shown in FIG. 1, the fastener driver 100 includes a power supply. In this example, the power supply is a direct current power supply. In this example, the direct current power supply is a rechargeable battery pack 300, and the battery pack 300 mates with a corresponding power supply circuit to supply power to the fastener driver 100. It is to be understood by those skilled in the art that in other examples, the fastener driver 100 may be powered by other power supply devices. For example, the power supply may be the alternating current wire connected to mains power, or the power supply may be other connection cables that can be connected to the power supply device. The corresponding components in the fastener driver 100 are powered through mains power or other power supply devices in conjunction with corresponding rectifier, filter, and voltage regulator circuits. The battery pack 300 is used below instead of the power supply, but it is not regarded as a limitation to the present application.

The battery pack 300 may be a lithium battery pack, a solid-state battery pack, or a pouch battery pack. In some examples, when the power supply includes multiple battery packs 300, the battery packs 300 may be of the same type or different types. In some examples, the electrical parameters, structural parameters, and physical parameters of the multiple battery packs 300 may be the same or different. In some examples, the nominal voltage of the battery pack 300 is greater than or equal to 10 V and less than or equal to 80 V. For example, the nominal voltage of the battery pack 300 is 10.8 V, 24 V, 36 V, 48 V, 56 V, or 80 V. The nominal voltage generally refers to the voltage specified by the manufacturer or the vendor through the label, packaging, user manual, specification, advertisement, marketing document, or another support document of each of the products so that the user knows which power tool 200a can run with the battery pack. Alternatively, the nominal voltage of the battery pack 100 may be acquired by being detected or calculated.

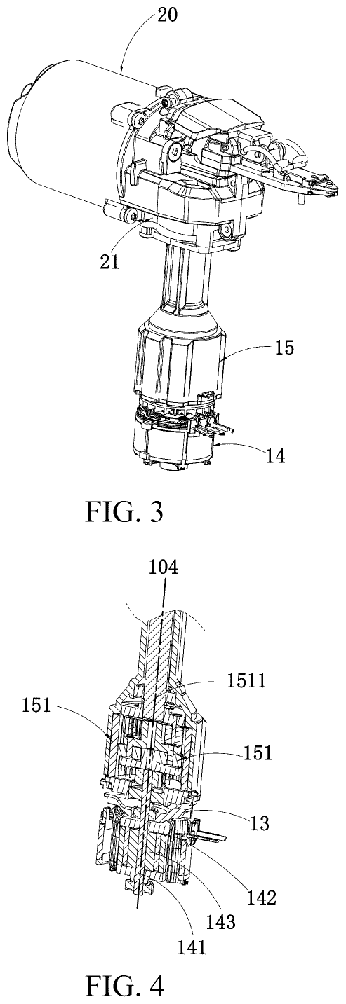

As shown in FIGS. 1 to 3, the fastener driver 100 includes a housing 11, a striking assembly 12, and a power mechanism 20. The housing 11 is configured to support the striking assembly 12 and the power mechanism 20. The power mechanism 20 includes a motor. The striking assembly 12 includes a striking member 121 for driving a fastener. Optionally, the striking member 121 is configured to drive the fastener into the working surface 200 along the direction of a striking straight line 101. The striking member 121 is a sheet element extending along a plane parallel to the direction of the striking straight line 101, and the axis defined by the striking member 121 coincides with the striking straight line 101. The power mechanism 20 is configured to drive the striking member 121 to move along the direction of the striking straight line 101, thereby impacting and driving the fastener into the working surface 200 along the direction of the striking straight line 101.

To conveniently describe the technical solutions of the present application, the front and rear direction and the up and down direction are defined as shown in FIG. 1, where the front and rear direction is parallel to the striking straight line 101, the direction from the striking member 121 to the fastener is the front, and the up and down direction is perpendicular to the front and rear direction.

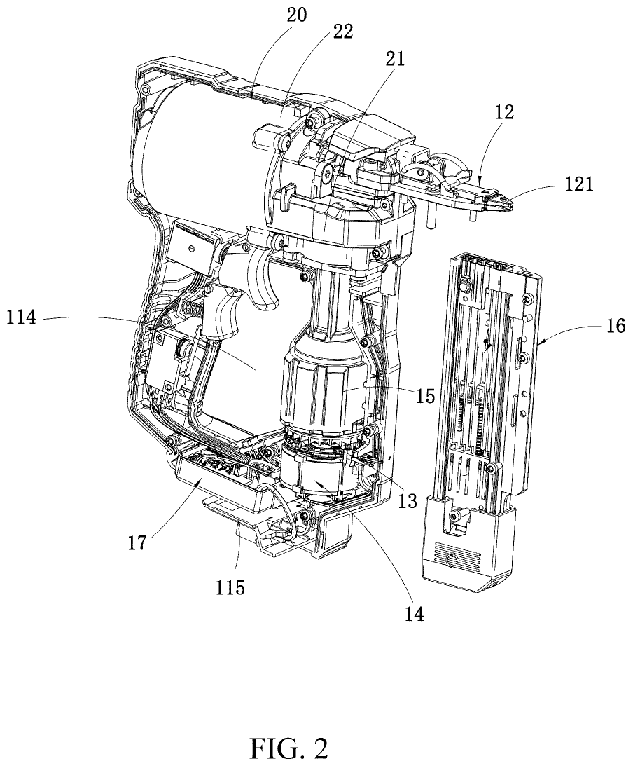

As shown in FIGS. 2 to 4, in this example, the motor is disposed in the housing 11, and the motor is configured to provide power for the power mechanism 20. In this example, the motor is specifically an electric motor 14, and the electric motor 14 provides power for the power mechanism 20. It is to be understood that in other examples, the motor may be another form of power source, such as an engine. In the present application, for ease of description, the electric motor 14 is used for description. As shown in FIG. 4, the electric motor 14 is an inrunner. The inrunner includes a stator assembly 142 and a rotor assembly 143. The rotor assembly 143 includes a motor shaft 141 configured to output power, and the stator assembly 142 surrounds the motor shaft 141. The motor shaft 141 is rotatable about a motor axis 104 relative to the housing 11 to output power. It is to be understood that in other examples, the electric motor 14 may be an outrunner. One battery pack 300 is detachably mounted to the housing 11. When the battery pack 300 is mounted to the housing 11, the battery pack 300 can supply power to at least the electric motor 14 to enable the electric motor 14 to operate.

As shown in FIGS. 1, 2, and 5, the power mechanism 20 includes a drive assembly 21, a gas spring mechanism, and a firing assembly 23. The drive assembly 21 is configured to drive the gas spring mechanism to store energy. The firing assembly 23 is formed with or connected to the striking member 121. The firing assembly 23 is configured to be movable along the direction of a second straight line 103 relative to the housing 11. When moving along the direction of the second straight line 103, the firing assembly 23 drives the striking member 121 to move along the direction of the striking straight line 101. The gas spring mechanism stores energy configured to drive the firing assembly 23 to move and drives the firing assembly 23 to move along the second straight line 103 when releasing the energy, thereby driving the striking member 121 to move along the direction of the striking straight line 101.

As shown in FIGS. 1 and 2, the fastener driver 100 further includes a magazine assembly 16 disposed at the front end of the housing 11. The magazine assembly 16 is configured to accommodate fasteners. The magazine assembly 16 can push the fasteners one by one into the striking assembly 12.

As shown in FIG. 1, the housing 11 includes a body portion 111, a motor accommodation portion 113, and a handle portion 112. The body portion 111 is formed with a first accommodation cavity for accommodating at least part of the gas spring mechanism. The electric motor 14 is disposed in the motor accommodation portion 113. The handle portion 112 is configured to be held by the user to operate the fastener driver 100. The motor accommodation portion 113 and the handle portion 112 extend downward from the lower part of the body portion 111. The motor accommodation portion 113 on the front side and the handle portion 112 on the rear side extend substantially parallel to each other.

As shown in FIG. 1, the housing 11 further includes a coupling portion 115 coupled to the battery pack 300, and the battery pack 300 can be detachably mounted to the coupling portion 115. The coupling portion 115 spans between the motor accommodation portion 113 and the end portion of the handle portion 112. Optionally, the coupling portion 115 is disposed at an end of the handle portion 112 facing away from the body portion 111. The battery pack 300 is mounted to the coupling portion 115 along a direction intersecting the direction of the second straight line 103. In some examples, the battery pack 300 is mounted to the coupling portion 115 along a direction parallel to the second straight line 103.

The fastener driver 100 further includes a trigger 18 mounted to the handle portion 112. When holding the handle portion 112, the user operates the trigger 18 to activate the trigger 18. The trigger 18 is configured to be operated by the user to activate the fastener driver 100, and the trigger 18 further includes an operating surface 181 configured to be operated by the user. When the user holds the handle portion 112 by the hand, the user's index finger may be in contact with the operating surface 181 to pull the trigger 18. The operating surface 181 is the front surface of the trigger 18. In this example, the operating surface 181 is an arc surface that fits the user's finger.

As shown in FIG. 1, a through hole 114 configured to allow the user's hand to pass through is formed between the motor accommodation portion 113 and the handle portion 112. In this example, the body portion 111 is on the upper side of the handle portion 112 and the motor accommodation portion 113, and the body portion 111 connects the handle portion 112 to the motor accommodation portion 113; the coupling portion 115 is on the lower side of the handle portion 112 and the motor accommodation portion 113, and the coupling portion 115 connects the handle portion 112 to the motor accommodation portion 113. In this manner, the body portion 111, the motor accommodation portion 113, the coupling portion 115, and the handle portion 112 are connected in sequence to surround the through hole 114. It is to be understood that in other examples, the coupling portion 115 may be not connected to the handle portion 112 and the motor accommodation portion 113. In this manner, the through hole 114 is a region between the handle portion 112 and the motor accommodation portion 113. The through hole 114 penetrates the housing 11 in the left and right direction perpendicular to the second straight line 103. When the user's hand holds the handle portion 112, the user's fingers can be at least partially located in the through hole 114, or the fingers can pass through the through hole 114 so that the user's palm and fingers can surround the handle portion 112 to hold the handle portion 112 tightly. The trigger 18 is disposed in the region of the through hole 114.

As shown in FIG. 2, the fastener driver 100 further includes a deceleration mechanism 15 disposed between the electric motor 14 and the power mechanism 20. The deceleration mechanism 15 connects the electric motor 14 to the power mechanism 20, thereby transmitting the power outputted by the electric motor 14 to the power mechanism 20. The deceleration mechanism 15 reduces the rotational speed outputted by the electric motor 14 and outputs the reduced rotational speed. The deceleration mechanism 15 is at least partially disposed in the motor accommodation portion 113.

As shown in FIG. 4, in this example, the deceleration mechanism 15 includes a first deceleration assembly 151, and the first deceleration assembly 151 uses the planet gear for deceleration. The working principle according to which a planetary gear train performs the deceleration and the deceleration implemented by the transmission mechanism have been completely disclosed to those skilled in the art. Therefore, the detailed description is omitted herein for the brevity of the specification.

In this example, the fastener driver 100 further includes a shaft locking assembly, and the shaft locking assembly (not shown in the figure) transmits power to an output shaft 1511. The shaft locking assembly allows power to be transmitted from the electric motor 14 to the output shaft 1511 while preventing power from being transmitted from the output shaft 1511 to the electric motor 14. The structure of the shaft locking assembly belongs to the relatively common technology, and the details are not repeated here.

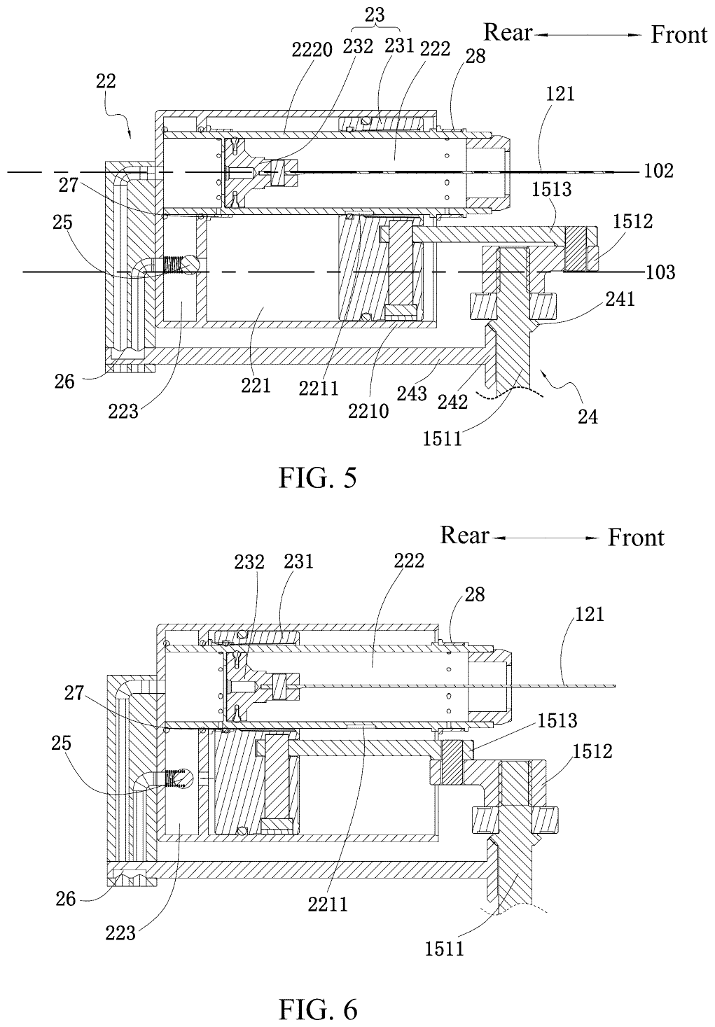

As shown in FIG. 5, in this example, the gas spring mechanism includes the cylinder assembly 22. The cylinder assembly 22 includes a first cylinder 221 and a second cylinder 222. The second cylinder 222 is partially or completely disposed in the first cylinder 221. The first cylinder 221 includes a first cylinder cavity 2210 extending along the direction of the second straight line 103, and the second cylinder 222 is partially or completely disposed in the first cylinder cavity 2210. The second cylinder 222 includes a second cylinder cavity 2220 extending along the direction of a first straight line 102, where the second straight line 103 is parallel to the first straight line 102.

The firing assembly 23 is disposed in the cylinder assembly 22 and includes a first piston 231 and a second piston 232. The first piston 231 is partially or completely disposed in the first cylinder cavity 2210. The second piston 232 is disposed in the second cylinder cavity 2220. An end of a drive rod 1513 is connected to the first piston 231. Driven by the rotating electric motor 14, the drive rod 1513 can push the first piston 231 to reciprocate along the direction of the second straight line 103 in the first cylinder cavity 2210. The second piston 232 can reciprocate along the direction of the first straight line 102 in the second cylinder cavity 2220.

In some examples, the motor shaft 141 of the electric motor 14 is connected to the deceleration mechanism 15, the power of the motor shaft 14 is outputted through the deceleration mechanism 15 via the output shaft 1511, the output shaft 1511 is connected to a crank 1512, the crank 1512 is rotationally connected to the drive rod 1513, and the rotation axis of the output shaft 1511 is eccentrically disposed relative to the connection axis of the crank 1512 and the drive rod 1513. The drive rod 1513 is connected to the first piston 231. During the rotation of the electric motor 14, the crank 1512 is driven to rotate, and the crank 1512 drives the drive rod 1513. Through the eccentric movement principle of the crank-connecting rod, the first piston 231 is driven to reciprocate along the direction of the second straight line 103 in the first cylinder cavity 2210, thereby converting the rotational motion into the reciprocating linear motion.

As shown in FIG. 5, the striking member 121 and the second piston 232 are fixedly connected. It is to be understood that the striking member 121 and the second piston 232 that are connected cannot be disassembled by the hand. During the movement, the striking member 121 moves synchronously with the second piston 232. The second piston 232 is connected to the striking member 121, and the second piston 232 and the striking member 121 reciprocate along the direction of the second straight line 102 in the second cylinder cavity 2220. The user fills the nails into the magazine assembly 16, and the second piston 232 pushes the striking member 121 to move and drive the nail out.

Since the requirements for the nailing efficiency and nailing force are upgraded constantly, higher pressure needs to be acquired in the process of compressing air to store energy in order that the compressed air-driven nail gun can acquire a stronger nailing capability. However, due to the limited space of the housing 11 of the compressed air-driven nail gun, under the premise that the volume of the cylinder 221 is fixed, it is difficult to provide a stronger driving force to the piston to achieve the better nailing efficiency and nailing force.

In an example, the present application provides the fastener driver 100. In the case where the striking member 121 of the fastener driver 100 is at the stop position, the first cylinder 221 connects with the outside atmosphere, and the first piston 231 is at the initial position. It is defined that one time of gas compression is completed in the case where the first piston 231 moves backward from the initial position to the maximum compression position. When the first piston 231 reaches the maximum compression position for the Nth time, the striking member 121 is released from the stop position to strike the fastener, where N is greater than or equal to 2. Specifically, N may be 2, 3, 4 . . . . By increasing the number of times of gas compression, in the case where the space is fixed and the compression rate is fixed, compared with one time of air compression, multiple times of air compression can obtain a higher gas pressure. The higher the pressure of the compressed air is, the stronger the force acting on the striking member 121 is, and the stronger the nailing capability of the striking member 121 is in the case where the space of the housing 11 is fixed.

In an example, the present application provides the fastener driver 100. In the case where the striking member 121 of the fastener driver 100 is at the stop position, the first cylinder 221 connects with the outside atmosphere, and the first piston 231 is at the initial position. It is defined that one time of gas compression is completed in the case where the first piston 231 moves backward from the initial position to the maximum compression position, and the striking member 121 is maintained at the stop position in the case where the first piston 231 reaches the maximum compression position for the first time. Moreover, when the first piston 231 reaches the maximum compression position for the Nth time, the striking member 121 is released from the stop position to strike the fastener, where N is greater than or equal to 2. By increasing the number of times of gas compression, in the case where the space is fixed and the compression rate is fixed, compared with one time of air compression, multiple times of air compression can obtain a higher gas pressure. The higher the pressure of the compressed air is, the stronger the force acting on the striking member 121 is, and the stronger the nailing capability of the striking member 121 is in the case where the space of the housing 11 is fixed.

It should be noted that the stop position is a rear-most position of the striking member in a return stroke. But the rear-most positions of different return strokes might be slightly different with each other because the wornness of the parts of the fastener driver 100 may affect the accurate location of the stop positions.

As shown in FIG. 5, the fastener driver 100 includes an energy storage cylinder 223 unidirectionally connecting with the first cylinder 221 and configured to store compressed gas. The fastener driver 100 further includes a first valve 25 disposed at the connection between the energy storage cylinder 223 and the first cylinder 221 of the cylinder assembly 22 and selectively allowing the gas in the first cylinder 221 to flow into the energy storage cylinder 223. For example, the first valve 25 is a one-way valve, and one time of gas compression is completed during the process of the first piston 231 moving backward from the initial position to the maximum compression position. In this case, the first valve 25 opens and connects the first cylinder 221 with the energy storage cylinder 223 so that the compressed air in the first cylinder 221 flows unidirectionally to the energy storage cylinder 223 for storage. During the resetting process of the first piston 231, the first valve 25 closes to prevent the compressed gas in the energy storage cylinder 223 from flowing back to the first cylinder 221. The air is compressed multiple times by the first piston 231 and stored in the energy storage cylinder 223 so that the pressure of the compressed gas can be increased. In this manner, the pressure of the compressed gas can be effectively increased without increasing the volume of the cylinder.

By providing the energy storage cylinder 223, the compressed air can be stored in the energy storage cylinder 223 by utilizing the first cylinder 221, and the air is compressed multiple times through the first cylinder 221, thereby storing energy and increasing the air pressure in the energy storage cylinder 223. Moreover, the energy storage cylinder 223 connects with the second cylinder 222, and the compressed gas in the energy storage cylinder 223 is used to push the striking member 121 to perform the nailing action so that the striking effect of the driven striking member 121 on the fastener can be improved.

In some examples, the second cylinder 222 connects with at least the energy storage cylinder 223, the striking member 121 is disposed in the second cylinder 222, and the striking member 121 is pushed by the compressed gas to strike the fastener. The fastener driver 100 further includes a second valve 26 disposed at the connection between the energy storage cylinder 223 and the second cylinder 222 of the cylinder assembly 22 and allowing gas to flow between the energy storage cylinder 223 and the second cylinder 222. The second valve 26 is an on-off valve. When the air pressure in the energy storage cylinder 223 reaches the air pressure used by the striking member 121, the second valve 26 opens and allows the compressed air in the energy storage cylinder 223 to enter the second cylinder 222 to push the striking member 121 to perform the striking action. The second valve 26 is provided to control the on-off between the energy storage cylinder 223 and the second cylinder 222, thereby ensuring that the compressed gas storage and the nailing action do not affect each other.

In some examples, the on-off of the second valve 26 is driven by the electric motor 14, or in other words, the on-off of the second valve 26 is linked with the electric motor 14. For example, the electric motor 14 controls the first piston 231 to move so that the on-off of the second valve 26 is linked with the movement of the first piston 231.

For example, when the rotational parameter of the electric motor 14 is greater than or equal to a parameter threshold, the second valve 26 opens to allow the compressed gas in the energy storage cylinder 223 to enter the second cylinder 222 to push the striking member 121 to strike the fastener. The electric motor 14 rotates to push the first piston 231 to reciprocate along the direction of the second straight line 103 in the first cylinder cavity 2210, thereby compressing air. The number of revolutions of the electric motor 14 determines the number of times the first cylinder 221 compresses air into the energy storage cylinder 223. When the rotational parameter of the electric motor 14 is greater than or equal to the parameter threshold, it is determined that the energy storage is completed, and in this case, the second valve 26 opens to allow the compressed gas in the energy storage cylinder 223 to enter the second cylinder 222 for work. In some examples, the electric motor 14 may be communicatively connected to the second valve 26 through a controller, thereby controlling the on-off of the second valve 26 according to the rotational parameter of the electric motor 14. For example, the rotational parameter of the electric motor 14 includes the number of revolutions of the electric motor, the angle of rotation of the electric motor, the rotation time of the electric motor, the current change of the electric motor, the commutation parameter of the electric motor, or the like. The rotational parameter of the electric motor 14 includes a direct parameter representing the rotation of the electric motor or a calculation parameter obtained after unary and binary calculations.

In some examples, the second valve 26 opens when the first piston 231 reaches the maximum compression position for the Nth time. During multiple reciprocating motions, the first piston 231 unidirectionally compresses air into the energy storage cylinder 223 multiple times, thereby increasing the air pressure in the energy storage cylinder 223. After the compression is completed multiple times to satisfy the requirements, the compressed air in the energy storage cylinder 223 may be used to push the striking member 121 to move. By controlling the on-off of the second valve 26, the energy storage and nailing actions can be controlled.

In some examples, the second valve 26 is configured to open automatically when the air pressure in the energy storage cylinder 223 is greater than or equal to an air pressure threshold. The second valve 26 may be a pressure valve. When the air pressure in the energy storage cylinder 223 is greater than or equal to the air pressure threshold, the second valve 26 opens, thereby supplying air to the second cylinder 222. In the preceding manner, easy control is achieved, the structure is simple, and the implementation is easy.

In some examples, when the second valve 26 is configured to be an on-off valve, the fastener driver 100 further includes a transmission assembly 24 drivingly connected to the drive assembly 21 and the second valve 26, respectively, and the drive assembly 21 can control, through the transmission assembly 24, the second valve 26 to open or close. The transmission assembly 24 includes a first bevel gear 241 and a second bevel gear 242 meshing with each other. The first bevel gear 241 is connected to the electric motor 14 and driven by the electric motor 14 to rotate. Optionally, the first bevel gear 241 is fixedly sleeved on the output shaft 1511, and a transmission rod 243 of the second bevel gear 242 is drivingly connected to the second valve 26. When the electric motor 14 drives the output shaft 1511 to rotate, the first bevel gear 241 drives the second bevel gear 242 to rotate. Through the transmission rod 243, the second bevel gear 242 drives a valve stem of the second valve 26 to move, thereby adjusting the on-off state of the second valve 26. The second valve 26 has only two states: on and off. By using the transmission assembly 24 to control the second valve 26, the on-off of the second valve 26 can be accurately controlled and a rapid response can be ensured.

In some examples, the fastener driver 100 further includes a third valve 27 disposed at the connection between the first cylinder 221 and the second cylinder 222 and selectively allowing gas to flow from the second cylinder 222 into the first cylinder 221. The third valve 27 is also a one-way valve. When the first piston 231 in the first cylinder 221 moves backward from the initial position to the maximum compression position to compress the gas, the third valve 27 is in a closed state. After the second piston 232 is released from the stop position to drive the fastener out, the third valve 27 is in an open state when the first piston 231 makes a return stroke. When the first piston 231 returns to the initial position, a suction effect is created in the first cylinder 221 to form negative pressure. At the same time, the second cylinder 222 connects with the first cylinder 221 through the third valve 27 so that negative pressure is also formed in the second cylinder 222. Driven by atmospheric pressure, the second piston 232 is automatically reset and returns to the stop position. In the preceding manner, the second piston 232 can be automatically reset after nailing without setting a complicated mechanical structure.

In some examples, the fastener driver 100 further includes a fourth valve 28 disposed on the second cylinder 222 and capable of allowing gas in the second cylinder 222 to flow to the outside in the case where the striking member 121 is at the striking position. The fourth valve 28 is a one-way valve. When the second piston 232 pushes the striking member 121 to move to the striking position, the air in the second cylinder 222 needs to be discharged quickly. During this process, the fourth valve 28 opens so that the gas in the second cylinder 222 is pushed by the second piston 232 to be discharged quickly through the fourth valve 28, thereby reducing the resistance of the gas in the second cylinder 222 acting on the second piston 232, reducing the pressure loss of the second piston 232, and ensuring the striking force. For example, the fourth valve 28 is disposed at the end portion of the second cylinder 222, which is the striking position, and the fourth valve 28 is disposed along the circumferential direction of the second cylinder 222.

In some examples, an air supply port 2211 is disposed on the first cylinder 221; and in the case where the striking member 121 is at the stop position, the first piston 231 is at the initial position, and the air supply port 2211 enables the first cylinder 221 to connect with the outside. The air supply port 2211 is provided so that when the first piston 231 is at the initial position, the first cylinder 221 can connect with the outside atmosphere. When the first piston 231 moves from the initial position to the maximum compression position and passes over the air supply port 2211, the first cylinder 221 is in a sealed state, and the air can be effectively compressed in this case. When the first piston 231 moves from the maximum compression position to the initial position and passes over the air supply port 2211, the outside air enters the first cylinder 221 through the air supply port 2211, thereby making negative pressure disappear and allowing the first piston 231 to be reset quickly. Moreover, air is supplied to the first cylinder 221, thereby facilitating the next compression.

For example, the first valve 25 includes a valve body 251 and a biasing member 252, and the biasing member 252 applies a force to the valve body 251 in a direction of blocking the connection between the first cylinder 221 and the energy storage cylinder 223. When the first piston 231 moves backward from the initial position to the maximum compression position, the gas pressure in the first cylinder 221 is greater than the biasing force of the biasing member 252, the valve body 251 gradually separates from the connection between the first cylinder 221 and the energy storage cylinder 223, and the gas in the first cylinder 221 enters the energy storage cylinder 223. When the first valve 25 makes a return stroke, the valve body 251 moves toward the connection between the first cylinder 221 and the energy storage cylinder 223 at least under the biasing force of the biasing member 252, and the valve body 251 at least partially enters the connection between the first cylinder 221 and the energy storage cylinder 223, thereby disconnecting the gas flow between the first cylinder 221 and the energy storage cylinder. Optionally, the first valve 25 may also be a one-way valve in another form, such as a diaphragm check valve or a swing check valve.

The working process of the fastener driver 100 is described below.

In the initial state, as shown in FIG. 5, the first piston 231 is at the initial position. At this time, the first cylinder 221 connects with the air supply port 2211, the second valve 26 is in a connecting state, the third valve 27 opens, the first cylinder 221 connects with the second cylinder 222, and the energy storage cylinder 223 connects with the second cylinder 222.

During the first gas compression and energy storage, as shown in FIG. 6, through the crank 1512 and the drive rod 1513, the electric motor 14 drives the first piston 231 to move from the initial position to the maximum compression position, the first valve 25 opens, the second valve 26 and the third valve 27 close, and the air in the first cylinder 221 is compressed into the energy storage cylinder 223.

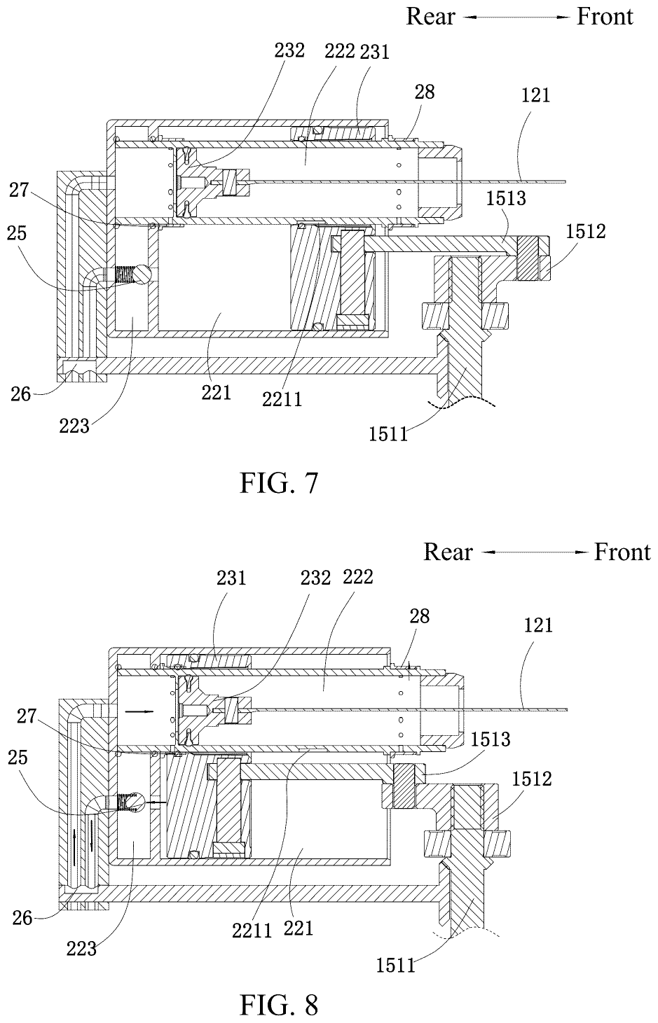

For the first piston 231 returning to the initial position, as shown in FIG. 7, through the crank 1512 and the drive rod 1513, the electric motor 14 drives the first piston 231 to move from the maximum compression position to the initial position, the first valve 25 closes, the pressure in the first cylinder 221 starts to drop, and the first valve 25 and the third valve 27 are both in the closed state before the pressure drops to atmospheric pressure; the first piston 231 continues moving until the pressure in the first cylinder 221 drops below atmospheric pressure, the third valve 27 opens, the second piston 232 remains at the bottom dead center under the action of negative pressure, and the electric motor 14 drives the first piston 231 to continue moving until the first piston 231 passes over the air supply port 2211 and reaches the initial position.

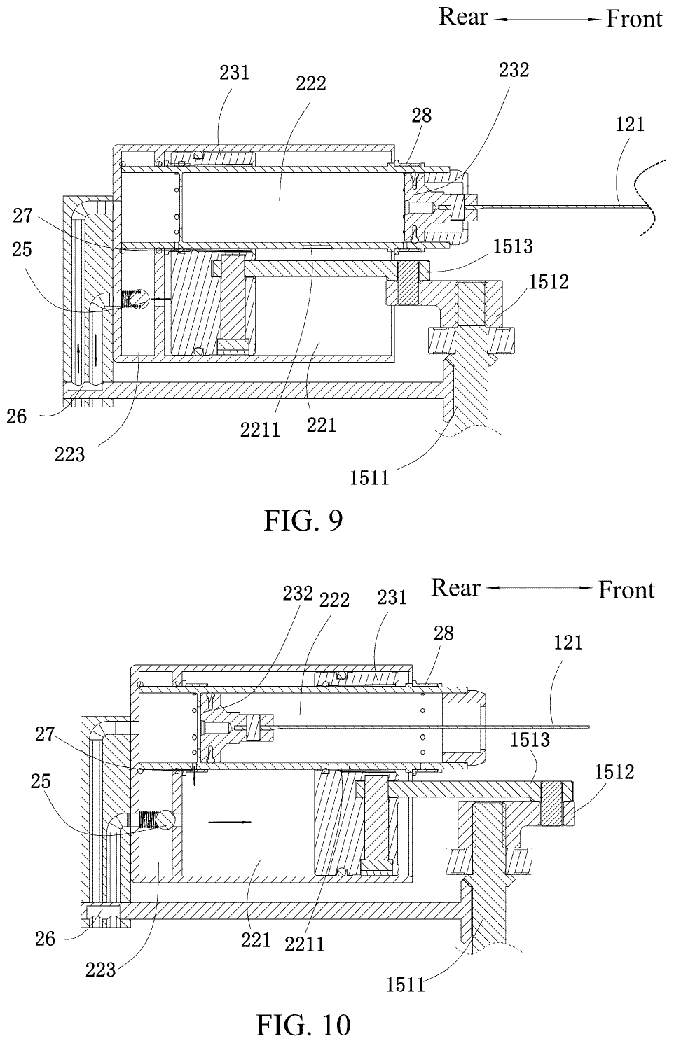

During the nailing process, the first gas compression and energy storage and the first piston 231 returning to the initial position are repeated until the first piston 231 moves to the maximum compression position for the Nth time as shown in FIG. 8, and then the nailing state starts. In this case, the second valve 26 is in the connecting state. As shown in FIG. 9, the compressed gas in the energy storage cylinder 223 enters the second cylinder 222 through the second valve 26, thereby pushing the striking member 121 to reach the bottom dead center and move forward to complete striking; the fourth valve 28 is in the open state, the second piston 232 moves to the top dead center and then stops, and the second piston 232 passes over the fourth valve 28 at this time.

During the process of the second piston 232 returning to the bottom dead center, as shown in FIG. 10, the first piston 231 is driven by the electric motor 14 to return to the initial position, both the second valve 26 and the first valve 25 close, the third valve 27 opens, and the second piston 232 returns to the bottom dead center under the action of the outside atmosphere, thereby completing a striking action.

As shown in FIG. 5, in another example, the present application provides the fastener driver 100. The fastener driver 100 includes the energy storage cylinder 223 unidirectionally connecting with the first cylinder 221 and configured to store compressed gas. The second cylinder 222 connects with at least the energy storage cylinder 223, the striking member 121 is disposed in the second cylinder 222, and the striking member 121 is pushed by the compressed gas to strike the fastener.

By providing the energy storage cylinder 223, the compressed air can be stored in the energy storage cylinder 223 by utilizing the first cylinder 221, and the air is compressed multiple times through the first cylinder 221, thereby storing energy and increasing the air pressure in the energy storage cylinder 223. Moreover, the energy storage cylinder 223 connects with the second cylinder 222, and the compressed gas in the energy storage cylinder 223 is used to push the striking member 121 to perform the nailing action so that the striking effect of the driven striking member 121 on the fastener can be improved.

As shown in FIG. 5, in some examples, the fastener driver 100 further includes the first valve 25 disposed at the connection between the energy storage cylinder 223 and the first cylinder 221 and allowing the gas in the first cylinder 221 to flow into the energy storage cylinder 223. The first valve 25 is a one-way valve, and one time of gas compression is completed during the process of the first piston 231 moving backward from the initial position to the maximum compression position. In this manner, the compressed air in the first cylinder 221 flows unidirectionally to the energy storage cylinder 223 for storage. During the resetting process of the first piston 231, the first valve 25 closes to prevent the compressed gas in the energy storage cylinder 223 from flowing back to the first cylinder 221. The air is compressed multiple times by the first piston 231 and stored in the energy storage cylinder 223 so that the pressure of the compressed gas can be increased. In this manner, the pressure of the compressed gas can be effectively increased without increasing the volume of the cylinder.

As shown in FIG. 5, in some examples, the fastener driver 100 further includes the second valve 26 disposed at the connection between the energy storage cylinder 223 and the second cylinder 222 and allowing gas to flow between the energy storage cylinder 223 and the second cylinder 222. The second valve 26 is an on-off valve. When the air pressure in the energy storage cylinder 223 reaches the air pressure used by the striking member 121, the second valve 26 opens and allows the compressed air in the energy storage cylinder 223 to enter the second cylinder 222 to push the striking member 121 to perform the striking action. The second valve 26 is provided to control the on-off between the energy storage cylinder 223 and the second cylinder 222, thereby ensuring that the compressed gas storage and the nailing action do not affect each other.

In some examples, the drive assembly 21 further includes the electric motor 14, and in the case where the rotational parameter of the electric motor 14 is greater than or equal to a parameter threshold, the second valve 26 opens to allow the compressed gas in the energy storage cylinder 223 to enter the second cylinder 222 to push the striking member 121 to strike the fastener. The electric motor 14 rotates to push the first piston 231 to reciprocate along the direction of the second straight line 103 in the first cylinder cavity 2210, thereby compressing air. The number of revolutions of the electric motor 14 determines the number of times the first cylinder 221 compresses air into the energy storage cylinder 223. When the rotational parameter of the electric motor 14 is greater than or equal to the parameter threshold, it is determined that the energy storage is completed, and in this case, the second valve 26 opens to allow the compressed gas in the energy storage cylinder 223 to enter the second cylinder 222 for work. The electric motor 14 may be communicatively connected to the second valve 26 through a controller, thereby controlling the on-off of the second valve 26 according to the rotational parameter of the electric motor 14.

In some examples, the second valve 26 is configured to open automatically when the air pressure in the energy storage cylinder 223 is greater than or equal to an air pressure threshold. The second valve 26 may be a pressure valve. When the air pressure in the energy storage cylinder 223 is greater than or equal to the air pressure threshold, the second valve 26 opens, thereby supplying air to the second cylinder 222. In the preceding manner, easy control is achieved, the structure is simple, and the implementation is easy.

In some examples, the cylinder assembly 22 further includes a connecting member configured to connect the first cylinder cavity 2210 with the second cylinder cavity 2220 so that the gas in the first cylinder cavity 2210 can enter the second cylinder cavity 2220 through the connecting member.

In some examples, when the drive assembly 21 pushes the first piston 231 to move from front to rear along the direction of the second straight line 103 in the first cylinder cavity 2210, the gas in the first cylinder cavity 2210 enters the second cylinder cavity 2220 through the connecting member. As the first piston 231 gradually approaches the connecting member, the air pressure born by the second piston 232 gradually increases. When the air pressure born by the second piston 232 reaches a preset threshold, the second piston 232 overcomes the attraction of the magnet and moves from the top dead center or the stop position to the bottom dead center or the striking position under the action of the air pressure, thereby pushing the striking member 121 to move forward and strike the nail.

As shown in FIG. 2, in some examples, a circuit board assembly 17 is further disposed in the coupling portion 115. The circuit board assembly 17 is electrically connected to the electric motor 14 to control the operation of the electric motor 14. A capacitor is disposed on the upper side of the circuit board assembly 17. An electrical connection terminal is disposed on the lower side of the circuit board assembly 17, and the electrical connection terminal is configured to be electrically connected to the battery pack 300 so that the battery pack 300 can supply power to the electric motor 14.

As shown in FIG. 2, the fastener driver 100 further includes a fan 13. The fan 13 is fixedly connected to the motor shaft 141 and can rotate synchronously with the motor shaft 141. The fan 13 is mounted to the upper end of the motor shaft 141. When the fan 13 rotates, the cooling airflow that flows into the housing 11 from the outside and then flows out of the housing 11 can be generated. An airflow inlet and an airflow outlet are formed on the housing 11. The position of the airflow inlet corresponds to the position of the fan 13, and the position of the airflow outlet corresponds to the position of the circuit board assembly 17. In this example, the capacitor with relatively high power is disposed on the circuit board assembly 17. The position of the airflow outlet also corresponds to the position of the capacitor. When the fan 13 rotates, the cooling airflow enters the housing 11 from the airflow inlet, flows through the circuit board assembly 17, and then flows out from the airflow outlet.

In some examples, a partition configured to separate the electric motor 14 from the circuit board assembly 17 may further be provided on the coupling portion 115 so that the heat generated during the operation of the electric motor 14 does not reach the circuit board assembly 17.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A fastener driver, comprising:
a striking assembly comprising a striking member configured to strike a fastener; and
a power mechanism comprising a gas spring mechanism for driving the striking member, the gas spring mechanism comprising at least a cylinder assembly comprising a first cylinder that is connected with an outside atmosphere when the striking member is at a stop position and a first piston disposed in the first cylinder;
wherein the first piston is at an initial position when the striking member is at the stop position, when the first piston moves from the initial position to a maximum compression position, a gas compression is completed, the striking member is released from the stop position when the first piston reaches the maximum compression position for an Nth time, and N is greater than or equal to 2.

2. The fastener driver of claim 1, further comprising an energy storage cylinder unidirectionally connecting with the first cylinder and configured to store compressed gas.

3. The fastener driver of claim 2, further comprising a valve disposed at a connection between the energy storage cylinder and the first cylinder and allowing gas in the first cylinder to flow into the energy storage cylinder.

4. The fastener driver of claim 2, further comprising a second cylinder, wherein the striking member is disposed in the second cylinder.

5. The fastener driver of claim 4, further comprising a first valve disposed at a connection between the energy storage cylinder and the second cylinder of the cylinder assembly and allowing gas to flow between the energy storage cylinder and the second cylinder.

6. The fastener driver of claim 5, wherein the power mechanism further comprises an electric motor, and, when a rotational parameter of the electric motor is greater than or equal to a parameter threshold, the first valve opens to allow the compressed gas in the energy storage cylinder to enter the second cylinder to push the striking member to strike the fastener.

7. The fastener driver of claim 5, wherein the first valve is configured to open automatically when air pressure in the energy storage cylinder is greater than or equal to an air pressure threshold.

8. The fastener driver of claim 5, further comprising a second valve disposed at a connection between the first cylinder and the second cylinder and allowing gas to flow from the second cylinder into the first cylinder.

9. The fastener driver of claim 8, wherein the second valve comprises a one-way valve.

10. The fastener driver of claim 5, further comprising a second valve disposed on the second cylinder and capable of allowing gas in the second cylinder to flow to the outside when the striking member is at a striking position.

11. The fastener driver of claim 5, further comprising a transmission assembly, wherein the transmission assembly is drivingly connected to the power mechanism and the first valve, respectively.

12. The fastener driver of claim 11, wherein the power mechanism is capable of controlling, through the transmission assembly, the first valve to open or close.

13. The fastener driver of claim 11, wherein the transmission assembly comprises a first bevel gear and a second bevel gear meshing with each other, and the second bevel gear is drivingly connected to the first valve.

14. The fastener driver of claim 5, wherein the first valve opens when the first piston reaches the maximum compression position for the Nth time.

15. The fastener driver of claim 1, wherein an air supply port is disposed on the first cylinder; and when the striking member is at the stop position, the first piston is at the initial position, and the air supply port enables the first cylinder to connect with the outside atmosphere.

16. A fastener driver, comprising:
a striking assembly comprising a striking member configured to strike a fastener; and
a power mechanism comprising a gas spring mechanism for driving the striking member, the gas spring mechanism comprising at least a cylinder assembly comprising a first cylinder that connects with an outside atmosphere when the striking member is at a stop position and a first piston disposed in the first cylinder;
wherein the first piston is at an initial position when the striking member is at the stop position, a gas compression is completed when the first piston moves from the initial position to a maximum compression position, and the striking member is maintained at the stop position when the first piston reaches the maximum compression position for a first time.

17. A fastener driver, comprising:
a striking assembly comprising a striking member configured to strike a fastener; and
a power mechanism comprising a gas spring mechanism for driving the striking member, the gas spring mechanism comprising at least a cylinder assembly comprising a first cylinder that connects with an outside atmosphere when the striking member is at a stop position, an energy storage cylinder unidirectionally connecting with the first cylinder and configured to store compressed gas, and a second cylinder connecting with at least the energy storage cylinder;
wherein the striking member is disposed in the second cylinder and the striking member is pushed by the compressed gas to strike the fastener.

18. The fastener driver of claim 17, further comprising a first valve disposed at a connection between the energy storage cylinder and the first cylinder and allowing gas in the first cylinder to flow into the energy storage cylinder.

19. The fastener driver of claim 18, further comprising a second valve disposed at a connection between the energy storage cylinder and the second cylinder and allowing gas to flow between the energy storage cylinder and the second cylinder.

20. The fastener driver of claim 19, wherein the power mechanism further comprises an electric motor, and. when a rotational parameter of the electric motor is greater than or equal to a parameter threshold, the second valve opens to allow the compressed gas in the energy storage cylinder to enter the second cylinder to push the striking member to strike the fastener.
